(19) United States
(12) Patent Application Publication
(10) Pub. No.: US 2010/0252448 A1
(43) Pub. Date: Oct. 7, 2010

(54) PROCESS FOR PRETREATMENT OF DRINKING WATER BY USING AN ION SELECTIVE MEMBRANE WITHOUT USING ANY CHEMICALS

(76) Inventor: Iván Raisz, Felsozsolca (HU)

Correspondence Address: HAHN & VOIGHT PLLC, 1012 14TH STREET, NW, SUITE 620, WASHINGTON, DC, 20005, US

(21) Appl. No.: 12/682,726

(22) PCT Filed: Oct. 10, 2008
(86) PCT No.: PCT/HU08/00118

§ 371 Date: May 20, 2010

(30) Foreign Application Priority Data
Oct. 12, 2007 (HU) P0700669

(51) Int. Cl. C02F 1/467

(52) U.S. Cl. 205/746

(57) ABSTRACT

The process according to the invention is suitable for eliminating organic contaminations and bacterial infections in water by using only electric current without the use of external oxygen source and without adding any oxidative chemicals. According to the process when preconditioning the water contaminated with organic materials and infected with bacteria for the purpose of drinking water the water is introduced to the anode space, where the anode space and the cathode space are separated from each other by anion selective membrane, while the hydroxyl ion containing solution is circulated through the cathode space. Hydroxyl ions passing through the membrane are converted to hydroxyl radicals on the anode, which by their strong oxidative activity intensively oxidize the organic materials, resulting in the control of bacteria.

### FIELD OF THE INVENTION

The present invention relates to a process for the preconditioning of waters contaminated by organic materials and/or infected by bacteria for purification of same for the purpose of drinking water. The invention can be characterized in that the water to be purified is introduced into a space between an anionic selective membrane and anode resisting to strongly oxidative effects and the solution comprising of hydroxyl ions is circulated in the space of the anionic selective membrane and the corrosion resistant cathode without the addition of an oxidising agent and a direct basic material and the purified water and the carbon dioxide containing oxygen gas formed in the anode space are by-passed from the anode space and hydrogen gas formed in the cathode space is by-passed from the cathode space.

### BACKGROUND OF THE INVENTION

The contamination of the waters on the surface and below the surface used in the water supplying systems has become a more and more serious problem and therefore there is a growing need for an efficient purification of waste waters (industrial and communal) and re-use of the purified waters. In the commonly used processes, particularly in case of organic contaminations and microbial infections chlorine-based or other processes resulting in toxic components are used. In drinking water supply and bath service the necessity/possibility of the elimination of bacteria is to be particularly examined.

In water preconditioning processes photo catalytic processes (Fujishima, A., Honda, K., Nature, 1972, 37, p. 238. and O Micic, O. I., Zhang, Y., Cromac, K. R., Trifumac, A. D., Thurnauer, M. C., J. Phys. Chem., 1993, 97, p. 7277.), requiring partially the addition of titanium dioxide and the partially the use of UV light source, are widely spread. The UV light not only promotes degradation processes, but addition of a catalyst is also required. Of the direct oxidation (chlorination and ozonization) processes chlorination has been used for almost a century. For chlorination liquefied chlorine has to be added, one of the risky elements of this process is the preparation, delivery and addition of the dangerous chlorine and the other risky element is the sometimes much higher (by order of magnitude) toxicity of the chlorinated hydrocarbons. In case of ozonizators ozone gets into the environment representing a risk (Delzell, E., Giesy, J., Munro, I., Doull, J., Mackay, D. and Williams, G. (1994). Regulatory Toxicology and Pharmacology 20 (1, Part 2 of parts): S1-S1056. White, G. C. (1985). Handbook of Chlorination. New York, Van Nostrand Reinhold Company. World Health Organization (1993). Guidelines for Drinking-Water Quality. 2nd Ed. Vol. I Recommendations).

This risk cannot be eliminated by inbuilt active charcoal filters.

In the course of the more than 100 years old Fenton process (Fenton, H. J. H. J. Chem. Soc. 1894, 65, 899) both Fe(II) ions and hydrogen peroxide are added from outside into the system to be oxidised. The system was first disclosed only in the 1930-ies.

Fe(II)+H₂O₂=Fe(III)+HO*+OH⁻ (1)

The formed HO* radical can react with a further Fe(II) particle,

Fe(II)+HO*=Fe(III)+OH⁻ (2)

or with an organic contaminating molecule, initiating the chemical degradation thereof.

It is therefore very important to ensure the optimal concentration of the Fe(II) ion. The most efficient way of carrying out this step to work under pH=3. (David A. Wink, Raymond W. Nims, Joseph E. Saavedra, William E. Utermahlen, Peter C. Ford: Proc. Natl. Acad. Sci. USA Vol. 91. pp. 6604-6608, July 1994. Chemistry).

The ratio of Fe(II) ion:H₂O₂ is 1:5-10 and the necessary

Fe(II) concentration is 25-50 mg/l. If the quantitative ratio of the necessary components is shifted, a potential danger situation occurs.

The relative oxidative potential of the hydroxyl radicals results in a potential emergency situation.

The relative oxidation potential of the hydroxyl radicals is shown in Table 1 [Walling, Cheves “Fenton's Reagent Revisited”, In Acts of Chem. Research, Vol. 8. pp. 125-131 (1975)].

TABLE 1
Relative Oxidation potential of the hydroxyl radicals

| | Relative oxidation ion potential related to |
|---|---|
| Oxidising agent | chlorine gas |
| hydroxyl radical | 2.06 |
| oxygen atom | 1.78 |
| hydrogen peroxide | 1.31 |
| perhydroxy radical | 1.25 |
| permanganate | 1.24 |
| hypobromic acid | 1.17 |
| hypochloric acid | 1.10 |

The chemical reactions of the hydroxyl radical in an aqueous medium are divided into 4 groups as follows:

addition: OH+C₆H₆→(OH)C₆H₆ (3).

hydrogen withdrawal: OH+CH₃OH→CH₂OH+H₂O (4).

electron transfer: OH+[Fe(CN)₆]⁴⁻→[Fe(CN₆]³⁻+OH (5).

interaction of radicals: OH+OH →H₂O₂ (6).

Fe(II) ions needed for the process can be provided by simply dissolving the metal by electrolysis, the preparation of hydrogen peroxide was however a more difficult task. Several processes were carried out in this aspect. The photochemical hydrogen peroxide generation is known from the prior art, said processes are known as photo Fenton processes (Leónidas A. Pérez-Estrada, Sixto Malato, Wolfgang Gernjak, Ana Agëera, E. Michael Thurman, Imma Ferrer and Amadeo R. Fernández-Alba: Environ Sci. Technol., 39 (21), 8300-8306, 2005).

When preparing hydrogen peroxide a carbon ring electrode is often used in the system, on which pure oxygen is bubbled and reduced (Samuele Meinero and Orfeo Zerbinati Chemosphere Volume 64 Issue 3, June 2006, pp. 386-392). Required output of the process is 0.3 kW h/g COD (chemical oxygen demand). The preparation of hydrogen peroxide takes place on the basis of the following equation by reducing the pure oxygen or the oxygen content of the air.

O₂+2H₂O+2e⁻=H₂O₂+2OH⁻ or O₂+2H⁺+2e⁻=H₂O₂ (7).

A significant problem of this technological process is the dissolution of oxygen in the electrolyte solution and the transport on the surface of the electrode governed by diffusion. Correspondingly the current density is far lower than 1 mA cm² (D. Pletcher and F. C. Walsh, Industrial Electrochemistry, Chapman and Hall, London, 1990). This process is thus of low output. According to Sahni et al. hydroxyl, hydrogen and oxygen radicals are prepared in an aqueous solution by bi-phase corona discharge, and are used for the degradation of PCB (polychlorinated biphenyl) (M. Sahni, W. C. Finney, B. R. Locke: J. Adv. Ox. Tech. 8 (1), (2005) pp. 105-111). In order to make the process more efficient the water has to be in each case acidified, what is not recommended when preconditioning drinking water.

Fenton reaction is used during the treatment of waste water in order to degrade the main part of the organic waste, to carry out the subsequent fine purification by biological degradation. (Andreja Zgarnar Gotvajn, Jana Tagorc-Koncan, Acta Chim. Slov. 2005, 52, 131-137).

Processes based on Fenton reaction are mainly applied today in the following environment protecting technologies:
to degrade organic contaminations,
to reduce toxicity,
to precondition biodegradation,
for deodorization and decolourization.

### SUMMARY OF THE INVENTION

We have now surprisingly found that the above problems can be solved by a substantially modified form of the classically used electro Fenton systems. We have found that as opposed to the processes known from the prior art according to the process of the invention no lye has to be introduced to the system, and no external oxygen source has to be used either.

### DETAILED DESCRIPTION OF THE INVENTION

A special solution is needed for the removal of hydrogen gas formed during the process and being utilized in a fuel cell.

When assembling the electrolysing system we had to bear in mind that the processes to be carried out are basically different from the processes known so far. In the course of the known processes called electro Fenton processes oxygen introduced into the system was reduced on the cathode. (J. Casado, J. Fornaguera, M. I. Galán: Water Research 40, 13, July 2006, pp. 2511-2516) and thus also hydrogen peroxide performing the oxidation was evolved on the cathode.

We have found that we can add hydroxyl ions to the solution to be purified without adding any lye. One of the preferred methods of the process according to the invention is the use of an ion selective membrane. By using an ion selective membrane, as it was confirmed by our experiments, the separation of oxygen formed in the anode space and hydrogen formed in the cathode space was also solved.

The two electrodes used for the process according to the invention are parallel and are placed between the ion selective membrane.

In order to ensure flexibility of the system we have developed electrolysis cell bodies of variable size which can be connected in series and to the two sides of great surface of which the electrodes, ion selective membranes may be adapted and the inlet and outlet of the test solutions is solved, and at the same time it is suitable for the collection and sampling of the formed gases as well.

During the development the optimal cell bodies required a different size and also different outlet and inlet possibilities.

According to an alternative method according to the present invention the anion selective membrane and the cathode may be wound up by the means of a spacer for better utilization of space.

The axis of the winding is to be vertical and gas is let out at the upper edges.

As we aimed to introduce hydroxyl ions into the anode space, we have of course applied an anion selective membrane. We have used several basis as a source of anion and examined optimal concentrations. We have preferably used sodium hydroxide and sodium carbonate.

When having determined optimal values, an exceptive condition was the lesion of the membrane (degradation, break of continuity during 24 hours function) and a concentration of at least 10⁻⁴ mol OH⁻ on the available membrane surface at the outlet orifice of the anode space at an applied volume flow rate of 2 ml/min.

The results are shown in Table 2.

TABLE 2
Suitability of OH⁻ Sources

| Solution | | Sodium hydroxide | Sodium carbonate |
|---|---|---|---|
| 1 | mol/l | − | − |
| 0.5 | mol/l | − | + |
| 0.1 | mol/l | − | + |
| 0.05 | mol/l | − | + |
| 0.02 | mol/l | + | + |
| 0.01 | mol/l | + | + |
| 0.001 | mol/l | + | − |
| 0.0001 | mol/l | − | − |

The data of Table 2 show that both sodium hydroxide and sodium carbonate solutions may be used in a wide concentration range. As the carbonate ion also passes through the anion selective membrane, it is a loss. Similarly the carbonate ion of sodium carbonate produces further hydroxyl ions on the cathode. (D. H. Bremner, A. E. Burgess, F. B. Li, Appl. Catal. A 203 (2000) 111):)

CO₃⁻+2H₂O+2e⁻=HCO₂⁻+2OH⁻ (8)

Hydroxyl ions are also formed on the cathode during the electrolysis of water.

2H₂O+2e=H₂+2OH⁻ (9)

The target reaction producing hydroxyl ions on the anode:

OH⁻=OH+e (10)

Considering all these reactions the solution flowing through cathode space A may be any substance of the indicated concentration but in case of sodium carbonate the conversion to sodium hydroxide is significant, and this can result in the degradation of the membrane in case of concentrations of 0.5 to 0.05 mole/l.

Generally the concentration of the OH⁻ ion cannot exceed 0.05 mole/l and cannot be lower than 0.001 mole/l, when using preferably sodium hydroxide or sodium carbonate.

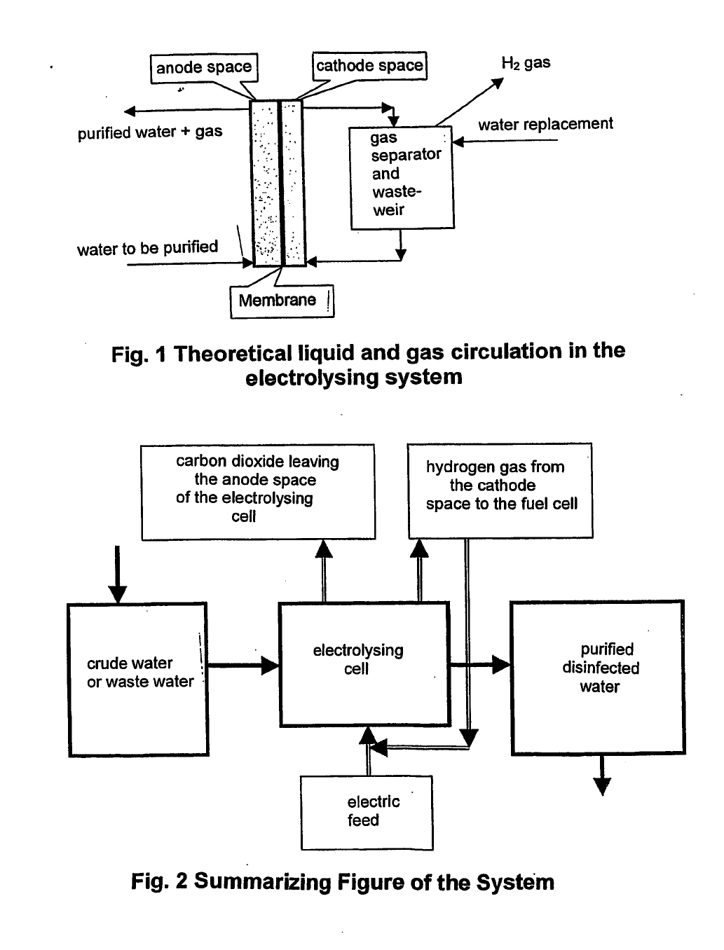

The amount of the solvent is reduced because of the hydroxyl ions transfused into the anode space from the catolyte solution, and hydrogen gas formed in the cathode space and the pH of the solution increases. In order to avoid this it is necessary to ensure the steadiness of the volume of the circulated catolyte solution (FIG. 1). Apart from a damage situation there is no need to add any chemicals. In connection with the above said circumstances carbonate formation does not cause any trouble.

Depending on the condition of the plant and the composition of the solution to be purified we measured about 10% carbon dioxide contents when having analysed the composition of the gases leaving the reactor. It had to be examined whether—although the liquid flow to be purified was excluded from the cathode space—we do not have to calculate with the classic electro Fenton processes in the anode space. The question may occur as it cannot be excluded that the formed hydroxyl ions recombine to form hydrogen peroxide:

2OH⁻=H₂O₂ (11)

Hydrogen peroxide then subsequently repeatedly results in a hydroxyl ion in the presence of Fe(II) ions according to equation (1) or is decomposed by oxygen emission. In order to clarify this problem distilled water saturated with benzene was passed through a pre electrolysing system. We have used an iron gold electrode pair in the pre-electrolysing system, in which the iron electrode was of a surface of 4 mm² and the cell current was 2 mA. The concentration of the thus deposited Fe(II) ions in the solution of volume flow rate of 2 ml/min was 17.5 mg/l. By the electro Fenton reaction in the anode space the efficiency increased by 15-30% depending on the quality and concentration of the contaminating material.

Gases formed in the two electrode spaces are well separated from each other, confirmed by chromatographic assays. In order to utilize hydrogen gas and in order to eliminate the source of danger we have applied a fuel cell according to FIG. 2.

Further details of the invention are outlined in the following Examples, which serve only for illustration and are not intended to limit the scope of invention.

### Example 1

### Testing the Degradation of Benzene

The test of the degradation of benzene was selected because it is an accepted opinion in the art that for the detection of the presence of hydroxyl ions it is the safest way to detect phenol formed in the first reaction step of the degradation of benzene.

In our test system the Fe(II) concentration was provided by inserting a pre-electrolysing equipment connected in series.

We have used an iron gold electrode pair in the pre-electrolysing system, in which the iron electrode was of a surface of 4 mm² and the cell current was 2 mA.

The concentration of the thus deposited Fe(II) ions in the solution of volume flow rate of 2 ml/min was 17.5 mg/l.

In our electrolysing system we have used gold electrode as cathode which remained intact on a copper base by means of a 5 μm thick aurification. As anode a DSA (dimensionally stable anode) anode was used. The useful surface of the built-in electrode was 16 cm². The used-power was applicable both in voltage generator and current generator working method. Amperage was measured in the range of 1 mA to 2 A for each measuring range with 1% precision class and the voltage was measured in a range of 2 to 40 V for each measuring range with 0.5% precision class. Electrolysing voltage was 22 V and the amperage was 210 mA (13.1 mA/cm²).

In the course of the degradation and disinfection tests of the organic material the distance between the electrodes and the membrane was 4 mm on both sides, therefore due to the inlet and outlet solutions the reactor can be regarded as an almost ideal displacement reactor.

The eluant was tested by HPLC, and on the basis of chromatograms the conversion takes place presumably as follows:

benzene→phenol→hydroquinone p-benzoquinone→maleic acid→oxalic acid →CO₂→H₂O

The determination of the carbon dioxide of the evolved gas was performed by gas chromatography.

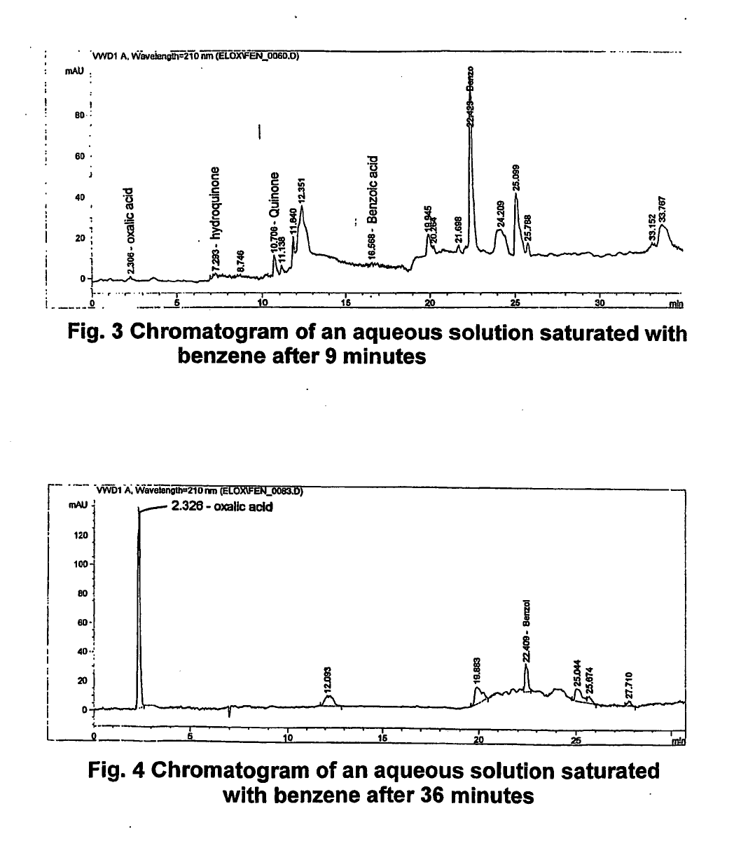

We have transferred through the system water saturated with benzene. The chromatogram belonging to 9 minutes of retention time is illustrated in FIG. 3 and the chromatogram belonging to retention time of 36 minutes is illustrated in FIG. 4. During the 25 minutes from the 9^{th} minute until the 36^{th} minute only 9.1% of benzene was retained. In this concentration phenol as a degradation product cannot be observed (13.5 minutes of elution time), as the degradation to metabolites of lower carbon atoms is so rapid. The pH of the solution is 1.5 already in the 9^{th} minute and in the 18^{th} minute it is already 1, showing the intensive increase of the amount of the degradation products. The change of the amount of phenol could precisely be followed only with a distilled aqueous solution of phenol of a conversion of 1.5 g/l, when during 9 minutes the concentration of phenol was reduced to 12.5 g/l under a current density of 22 mA/cm². Compared this with the result of Pelegrino et al. who had achieved a reduction of 99 mg/l during 300 minutes by using current density of 100 mA/cm² the process can be regarded efficient.

### Example 2

### Testing the Degradation of Terbutrine

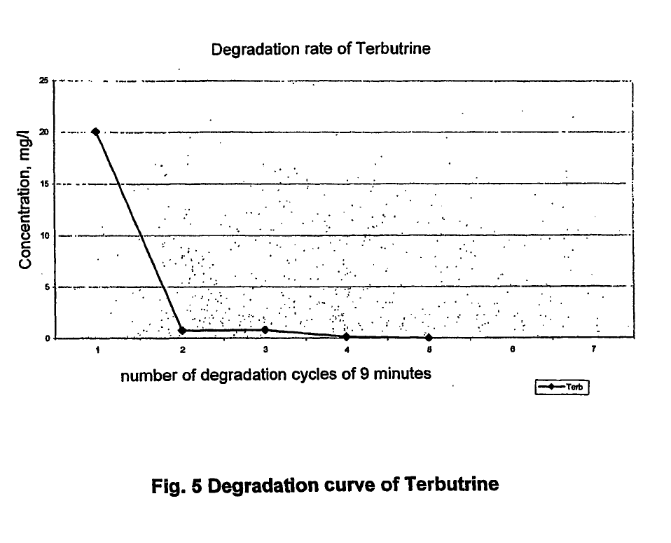

A saturated aqueous solution of terbutrine was selected for testing plant protecting agents (25 mg/l). This a good basis for examining the degradability of triazine derivatives. During the test we have examined a distilled aqueous solution of terbutrine under the conditions disclosed in Example 1. The results are shown in FIG. 5. The tests are illustrated for reelectrolysis cycles of 9 minutes mean retention time. In case of photo degradation more than 8 hours are required to reduce the amount of terbutrine below 5%, as opposed to the less than 30 minutes achieved by the electro oxidation developed according to the present invention.

### Example 3

### Disinfection Tests

We aimed to reduce the amount of bacteria in drinking water to the possibly greatest extent by electro oxidation. In the course of the intensive oxidation the contained organic material is also converted to carbon dioxide.

Measurements were carried out in the Regional ÁNTSZ Laboratory of Miskolc in Northern Hungary under the conditions of Example 1. We have selected from the commercially available mineral waters Szentkirályi, which is non gaseous and according to our tests free of chloride ions.

According to the toxicologists of ÁNTSZ the most risky bacteria occurring with waste waters were as follows:

Salmonella enteritidis

### Enteropathogen Escherichia Coli

Enterococcus faecalis, Enterococcus faecium
Staphylococcus aureus
Pseudomonas aeruginosa

The results are shown in Table 3.

TABLE 3
Disinfection test results

| | Before the | After the | After the | After the | After the | After the |
|---|---|---|---|---|---|---|
| Bacteria | process | process 1 | process 2 | process 3 | process 4 | process 5 |
| Salmonella | + | − | − | − | − | − |
| enteritidis | | | | | | |
| Escherichia | 16320 | 1 | 1 | 0 | 0 | 0 |
| Coli | | | | | | |
| Enterococcus | 16320 | 0 | 0 | 0 | 0 | 0 |
| faecalis | | | | | | |
| Pseudomonas | 16000 | 0 | 0 | 0 | 0 | 0 |
| aeruginosa | | | | | | |
| Staphylococcus | 16960 | 0 | 0 | 1 | 0 | 0 |
| aureus | | | | | | |

As it can be seen the process meets the criteria required of disinfection.

1. Process for the pretreatment of waters contaminated by organic materials and/or infected by bacteria for purification of same for the purpose of drinking water, comprising introducing the water to be purified into a space between an anionic selective membrane and anode resisting to strongly oxidative effects, preferably DSA, without the addition of an oxidising agent and a direct basic material, e.g. sodium hydroxide in to the main stream and the solution comprising of hydroxyl ions is circulated in the space of the anionic selective membrane and the corrosion resistant cathode and the purified water and carbon dioxide containing oxygen gas formed in the anode space are by-passed from the anode space and hydrogen gas formed in the cathode space is by-passed from the cathode space.

2. A process as claimed in claim 1 comprising that the two electrodes are parallel with each other and the anionic selective membrane is between them.

3. A process as claimed in claim 1 comprising that the anode, the membrane and the cathode are constructed by winding up same with keeping an appropriate space.

4. A process as claimed in claim 1 comprising bypassing the gases leaving from the anode space and the cathode space separately.

5. A process as claimed in claim 1 comprising the material of the anode being of DSA.

6. A process as claimed in claim 1 comprising the material of the anode being gold.

7. A process as claimed in claim 1 comprising to transfer the water to be purified through an electrolysing system before introducing same into the electrochemical oxidising system, the anode of which is an unalloyed iron.

8. A process as claimed in claim 1 comprising that the concentration of the OH⁻ion cannot exceed 0.05 mole/l and cannot be lower than 0.001 mole/l preferably by using sodium hydroxide or sodium carbonate.
